(19) United States
(12) Patent Application Publication
(10) Pub. No.: US 2014/0102265 A1
(43) Pub. Date: Apr. 17, 2014

(54) EXPANDABLE DRIVERS AND BITS

(71) Applicant: Devin Lee Looijen, Boulder, CO (US)

(72) Inventor: Devin Lee Looijen, Boulder, CO (US)

(21) Appl. No.: 13/651,397

(22) Filed: Oct. 13, 2012

(51) Int. Cl. B25B 23/00; B25B 15/00

(52) U.S. Cl. 81/445; 81/442; 173/1

(57) ABSTRACT

Apparatus and methods are provided for expanded driving heads used to drive torque-based fasteners (e.g., screws) into materials. The apparatus comprises a driving head that includes multiple prongs. Each prong comprises a tip adapted to engage a receptacle of a torque-based fastener. The tips of the prongs are also adapted to move apart from each other, thereby expanding the size of the driving head and engaging the receptacle of the torque-based fastener.

### FIELD OF THE INVENTION

The invention relates to devices that drive mechanical fasteners (e.g., screws, bolts, etc.) into or out of materials by applying torque to the fasteners.

### BACKGROUND

Screws and other torque-based mechanical fasteners are typically manufactured inexpensively. In order to achieve low costs of production, the dimensional tolerances (i.e., sizing constraints) for such fasteners allow for a great deal of variation between fasteners that would ideally be the same size. For example, “loose” tolerances can result in screw heads that are designed to be the same size (e.g., Phillips head #2), yet have differently sized receptacles (e.g., slots) for receiving a driving device such as a screwdriver. For example, one screw head may have a receptacle that snugly receives a Phillips head #2 screwdriver, while another screw head may have a receptacle that only loosely fits the same screwdriver. An additional characteristic of mechanical fasteners such as screws is that the very act of driving one into (or out of) a material can warp or otherwise strip the head.

Current screwdrivers and other driving devices encounter problems when attempting to drive screws (or other mechanical fasteners) that have worn or poorly sized heads. For example, a Phillips head screwdriver may wobble within receptacle of a screw head that is too loose. This causes a problem because when the screwdriver is rotated to drive the screw, the screwdriver may jump unexpectedly out of the screw head. This can be a particularly notable problem when a screw head is in a location that is hard to access, or when the screw is tightly lodged.

To illustrate the above problem, FIG. 1 on the left shows a top view of a Phillips head screw 100 that includes a receptacle 102. Receptacle 102 has been designed to have a width D. However, due to normal variations in manufacturing, the actual width of receptacle 102 is D+Δ. FIG. 1 on the right shows a screwdriver 150 inserted into receptacle 102 of screw 100. Because screw 100 has not been strictly toleranced, receptacle 102 is loose enough to allow screwdriver 150 to slip inside of it. Thus, screwdriver 150 will twist inside of receptacle 102 before it engages an edge of receptacle 102. This means that screwdriver 150 will not engage the entire surface of receptacle 102 when screwdriver 150 is rotated. Instead, only small locations along screwdriver 150 (indicated by elements 152, 154, 156, and 158) will engage with receptacle 102 when screwdriver 150 rotates screw 100. This focuses the torque applied by screwdriver 150 onto specific, small locations inside of receptacle 102 instead of spreading out the torque across the full interior surface of receptacle 102. Because the torque is not distributed across the entirety of receptacle 102, it is more likely that screwdriver 150 will cause excess stress that strips the surfaces of receptacle 102. This increased stress may also cause screwdriver 150 to jump out of receptacle 102 when it is driven.

### SUMMARY

The embodiments described herein address the above and other problems by providing driving heads (e.g., bits) and corresponding driving devices (e.g., screwdrivers) that expand in size to more fully engage a receptacle of a torque-based fastener (e.g., a screw, bolt, etc.). By expanding in size, these heads more fully grip walls of the receptacle. This reduces the chance of stripping a head of a mechanical fastener. Additionally, this reduces the chance that the head will jump out of the receptacle while applying torque to drive the fastener.

One embodiment provides an apparatus. The apparatus includes a driving head that comprises multiple prongs. Each prong includes a tip adapted to engage a receptacle of a torque-based fastener. The tips of the prongs are also adapted to move apart from each other, thereby expanding the size of the driving head and engaging the receptacle of the torque-based fastener.

Another embodiment is a method. The method comprises inserting a driving head that includes multiple prongs into a receptacle of a torque-based fastener. The method also comprises expanding the distance between the tips of the prongs of the driving head, thereby engaging the tips with internal walls of the receptacle. The method further includes applying torque to the expanded driving head.

Another embodiment comprises a kit. The kit includes a shaft comprising a threaded portion and an end portion. The kit further comprises a driving head. The driving head includes a shell defining a cavity that includes a threaded void adapted to receive the threaded portion of the shaft. The driving head further comprises multiple prongs, each prong comprising a tip adapted to engage a receiving surface of a torque-based fastener. The tips of the prongs are adapted to move apart from each other, thereby expanding the size of the driving head to more fully engage the torque-based fastener. The end portion of the shaft is adapted to penetrate the cavity as the threaded portion of the shaft is inserted into the threaded void, thereby applying force to the prongs and deflecting the tips of the prongs away from each other.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a diagram illustrating top views of a screw in an exemplary embodiment.

FIG. 2 is a diagram illustrating a side views of a screw driven by an enhanced screwdriver in an exemplary embodiment.

FIG. 3 is a diagram illustrating views of a shaft of an enhanced torque-based driving system in an exemplary embodiment.

FIG. 4 is a diagram illustrating multiple end portions of shafts in an exemplary embodiment.

FIG. 5 is a diagram illustrating views of a driving head comprising multiple prongs in an exemplary embodiment.

FIG. 6 is a diagram illustrating cut-away views of a driving head in an exemplary embodiment.

FIG. 7 is a diagram illustrating cut-away views of a driving head with prongs that have been separated by a shaft in an exemplary embodiment.

FIG. 8 is a diagram illustrating a top view of prongs of a driving head inserted into a receptacle of a torque-based fastener in an exemplary embodiment.

FIG. 9 illustrates a further expandable driving head in an exemplary embodiment.

FIG. 10 illustrates a further expandable driving head implemented in a screwdriver in an exemplary embodiment.

FIG. 11 illustrates a further driving head that utilizes a collar in an exemplary embodiment.

FIG. 12 illustrates examples of front views of hexagonal driving heads that include prongs in an exemplary embodiment.

FIG. 13 illustrates an exemplary method for operating an enhanced driving head in accordance with features and aspects hereof.

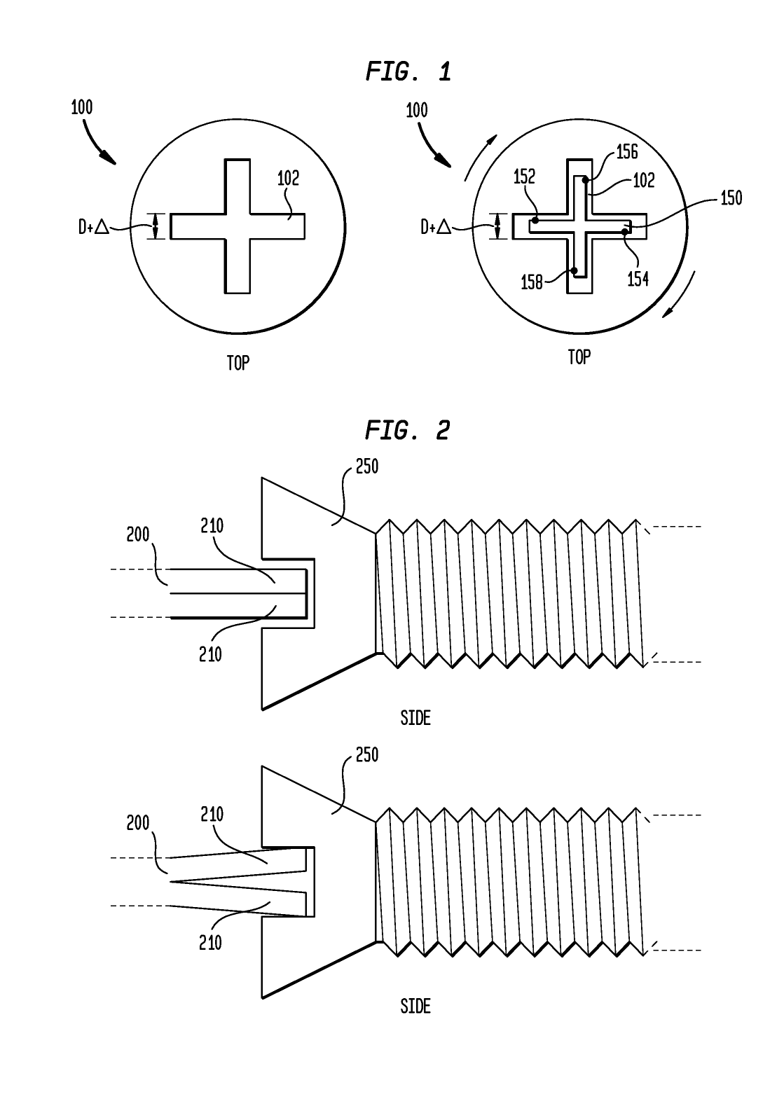

### DETAILED DESCRIPTION

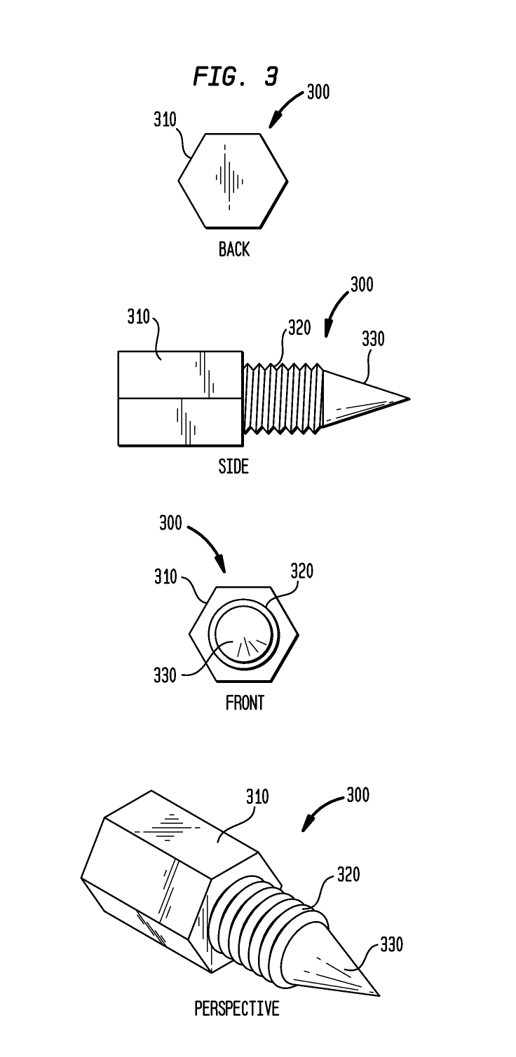

FIGS. 2-13 and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents. For example, the various shapes, dimensions, materials, and other characteristics depicted herein are merely exemplary.

FIG. 2 is a diagram illustrating a side view of a screw 250 driven by an enhanced screwdriver 200 in an exemplary embodiment. FIG. 2 illustrates a principle common to a number of the embodiments described in further detail below. The top portion of FIG. 2 illustrates that screwdriver 200, when inserted into screw 250, is loose within the receptacle of screw 250. However, screwdriver 200 has been enhanced so that its head includes multiple prongs 210. Prongs 210 may be moved apart from each other, in order to expand the size of the driving head of screwdriver 200. This in turn forces prongs 210 outward to more fully grip the surface of the receptacle of screw 250, as illustrated in the lower portion of FIG. 2. This enhancement prevents screwdriver 200 from slipping out of the receptacle of screw 250 when torque is applied to screwdriver 200.

FIGS. 3-7 illustrate the action of a multi-piece driving system capable of expanding to fill a receptacle in a torque-based fastener. Specifically, in FIGS. 3-7, the driving device includes a central shaft and a driving head. The central shaft is driven into the driving head. The driving head has multiple prongs, and as the central shaft is driven inside of the driving head, the central shaft forces the prongs of the driving head apart to fill the receptacle of the torque-based fastener.

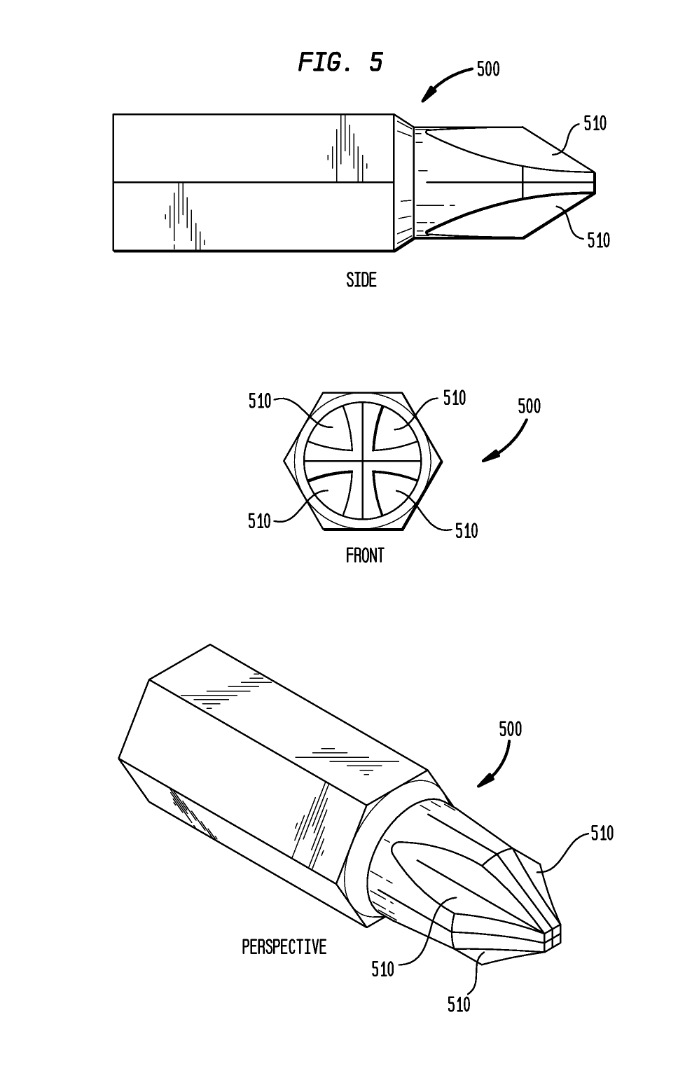

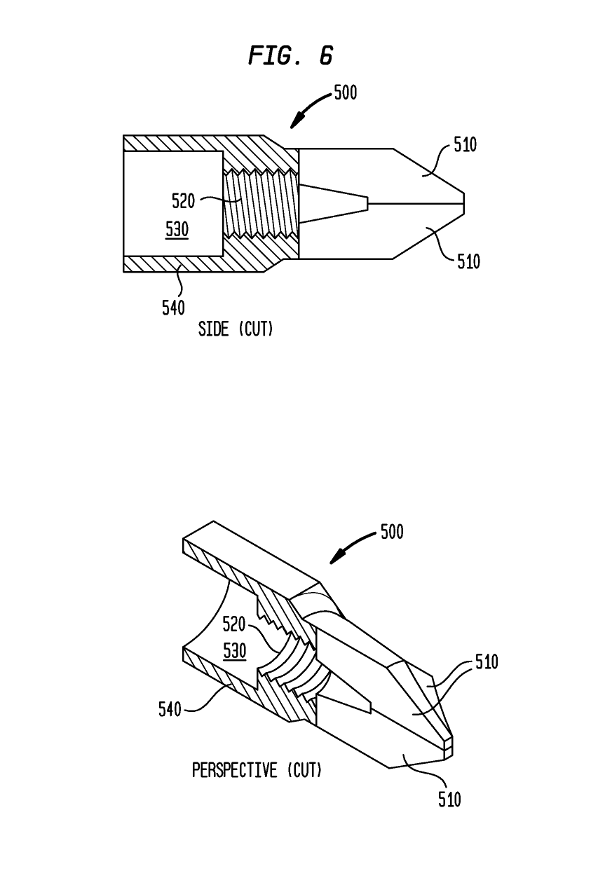

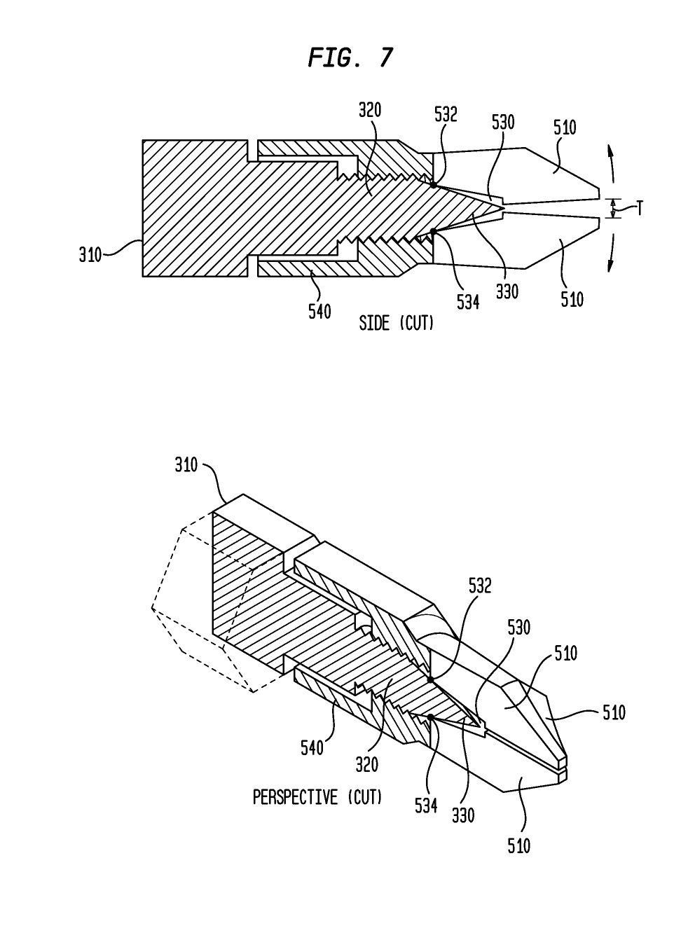

FIG. 3 is a diagram illustrating views of a shaft 300 of an enhanced torque-based driving system in an exemplary embodiment. Shaft 300 forms an inner piece of the driving system. As shaft 300 is rotated within the interior of an enhanced driving head (illustrated in FIGS. 5-6), it is capable of forcing its way into the driving head and applying force to prongs of the driving head. The force applied by shaft 300 flexes the prongs outward (as shown in FIG. 7). This allows the prongs to more fully grip a receptacle of a torque-based fastener (e.g., a screw).

According to FIG. 3, shaft 300 includes base 310, threaded portion 320, and end portion 330. End portion 330 is inserted into a cavity within the driving head of FIG. 6. As end portion 330 is pushed into the cavity, it flexes prongs of the driving head outward.

The flexion applied by end portion 330 to the prongs of the driving head may be elastic and fully recoverable by the prongs. Thus, in one embodiment the driving head may be used multiple times to drive multiple screws, because the shape memory of the prongs returns them to a closed, resting state once end portion 330 of shaft 300 is retracted.

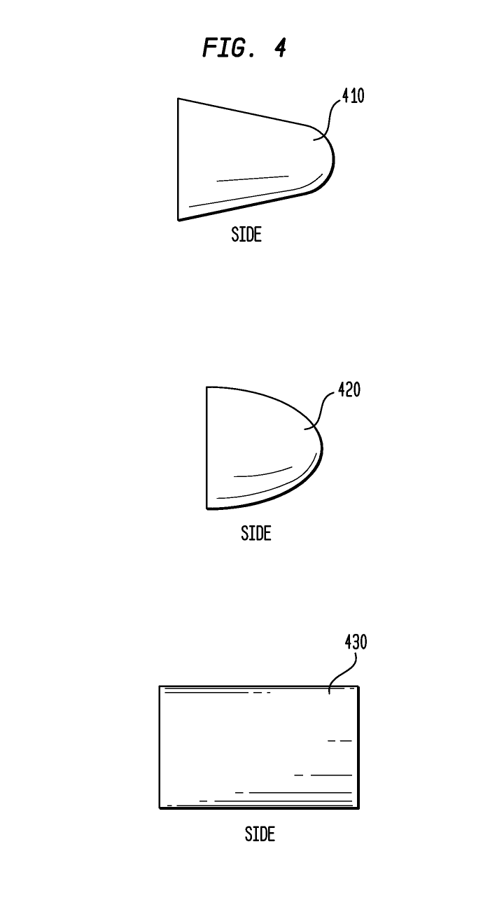

FIG. 4 is a diagram illustrating multiple end portions of shafts in an exemplary embodiment. Thus, while end portion 330 is illustrated as substantially cone shaped, in further embodiments, end portion 330 could form any arbitrary geometry capable of applying force to generate flexion at prongs of a driving head. For example, end portion 330 may comprise a blunt-nose tip 410, a hemispherical tip 420, a cylindrical tip 430, etc.

Threaded portion 320 of shaft 300 includes a thread adapted to be inserted into a cavity of the enhanced driving head of FIG. 6. As threaded portion 320 is rotated within the cavity, end portion 330 moves further into the driving head. The thread direction on threaded portion 320 may be normal (e.g., to expand prongs of the driving head when shaft 300 is rotated clockwise) or may be reversed (e.g., to expand prongs of the driving head when shaft 300 is rotated counterclockwise).

In one embodiment, threaded portion 320 and end portion 330 occupy the same location along shaft 300. In effect, in one embodiment end portion 330 and threaded portion 320 may be integrated into the same part of shaft 300.

Base portion 310 may include a hexagonal cross-section dimensioned so that it may be placed into a screwdriver capable of receiving interchangeable heads. In another embodiment, base portion 310 may have a cross section that may be gripped by the jaws of a chuck (e.g., a circular cross section, triangular cross section, hexagonal cross-section, etc.).

Each component of shaft 300 may be a different material, or the entirety of shaft 300 may be formed (e.g., cast) as a single piece. These components may be made from durable, strong materials such as steel, aluminum, carbon fiber, titanium, metal alloys, etc. It may be desirable for these materials to exhibit elastic deformation properties so that the various described components exhibit shape memory.

FIG. 5 is a diagram illustrating views of a driving head 500 that comprises multiple prongs 510 in an exemplary embodiment. Driving head 500 is adapted to receive shaft 300, and the prongs of driving head 500 are adapted to separate from each other as shaft 300 is driven into driving head 500.

In this embodiment, driving head 500 comprises a Phillips head bit which has been separated by a fine cut (or molded, milled, etc.) into four separate prongs 510. Thus, in a resting state, the tips of prongs 510 may actually be touching each other. In further embodiments, a circular hole may be placed at the end of the cut or gap that separates prongs 510 (e.g., at an end located away from the tips of prongs 510). This prevents crack propagation along driving head 500 when the tips of prongs 510 are separated. While depicted as a Phillips head driver in FIG. 5, driving head 500 may comprise any torque-based drive head (e.g., flathead, star drive, Torx® brand drivers, etc.). The number of prongs 510 within driving head 500 may also vary. For example, a flathead driver may be separated into two prongs: one per side. A hexagonal driver may be separated into anywhere from two to six prongs or even more, etc. The separation of a driving head into prongs may, for example, be made along one or more lines of symmetry for a given driving head when viewed from the front.

When driving head 500 is used, the tips of prongs 510 are driven apart from each other to form a gap between the tips of prongs 510. As the tips of prongs 510 are driven apart, they are moved closer to the walls of a receptacle of a torque-based fastener (e.g., screw or bolt) and eventually apply a force that pushes against (i.e., grips) those walls.

FIG. 6 is a diagram illustrating cut-away views of a driving head 500 in an exemplary embodiment. FIG. 6 reveals that driving head 500 includes a shell 540 that is integral with prongs 510. Shell 540 defines a portion of interior cavity 530, and prongs 510 may define a further portion of interior cavity 530. The interior cavity 530 includes a threaded void 520 dimensioned to receive threaded portion 320 of shaft 300. Threaded void 520 may be reverse threaded or normal threaded, with a pitch that matches the properties of threaded portion 320 of shaft 300. Threaded portion 320 may be rotated within threaded void 520 to drive end portion 330 into an interior edge of prongs 510. In driving systems intended for repeated use, shell 540 may have a wall thickness sufficient to prevent shell 540 from fracturing or breaking when shaft 300 forces prongs 510 apart.

Interior cavity 530 and end portion 330 are adapted to each other so that the further threaded portion 320 is driven into threaded void 520, the harder and deeper end portion 330 is pushed into prongs 510. This in turn flexes prongs 510 apart. For example, cavity 530 may slowly narrow in cross-sectional width while end portion 330 remains the same width, or vice versa. In a further embodiment, both cavity 530 and end portion 330 may narrow along their length, but at different rates. For example, cavity 530 may narrow along its length at a faster rate than end portion 330.

Prongs 510 may be dimensioned so that the extent of flexion applied by end portion 330 elastically deflects prongs 510. Therefore, when shaft 300 is withdrawn, prongs 510 may return to their original position. The specific location within cavity 530 that is engaged by end portion 330 may vary as a matter of design choice.

FIG. 7 is a diagram illustrating a cut-away view of a driving head 500 with prongs 510 that have been separated by the thrusting of an interior shaft 300 in an exemplary embodiment. In FIG. 7, an exemplary shaft 300 has been driven into driving head 500, so that end portion 330 impacts cavity 530. When driving head 500 is inserted into a receptacle of a torque-based fastener (not shown), the receptacle of the fastener may hold driving head 500 steady until the applied torque expands driving head 500. Driving head 500 continues expanding within the receptacle until the gap between the tips of prongs 510 reaches a size T. Once driving head 500 fully expands to grip the walls of the receptacle, further application of torque to shaft 300 will transfer and rotate driving head 500 instead of further flexing prongs 510. This is because the walls of the receptacle physically prevent prongs 510 from flexing any further outward. This in turn rotates the torque-based fastener. In a further embodiment, the length of threaded portion 320 or threaded void 520 may be dimensioned so that the threading (and/or shaft 300) hits a mechanical stop (e.g., base 310 or a portion of driving head 500) and is prevented from further rotation after being driven a given distance into driving head 500 and expanding prongs 510 a maximum amount.

In one embodiment as depicted in the bottom portion of FIG. 7, a hexagonal base portion 310 of a shaft 300 protrudes outward from driving head 500. Hexagonal base portion 310 may thus be inserted into a hexagonal socket of a screwdriver that supports interchangeable heads. In this manner, when the screwdriver is rotated, shaft 300 turns within driving head 500.

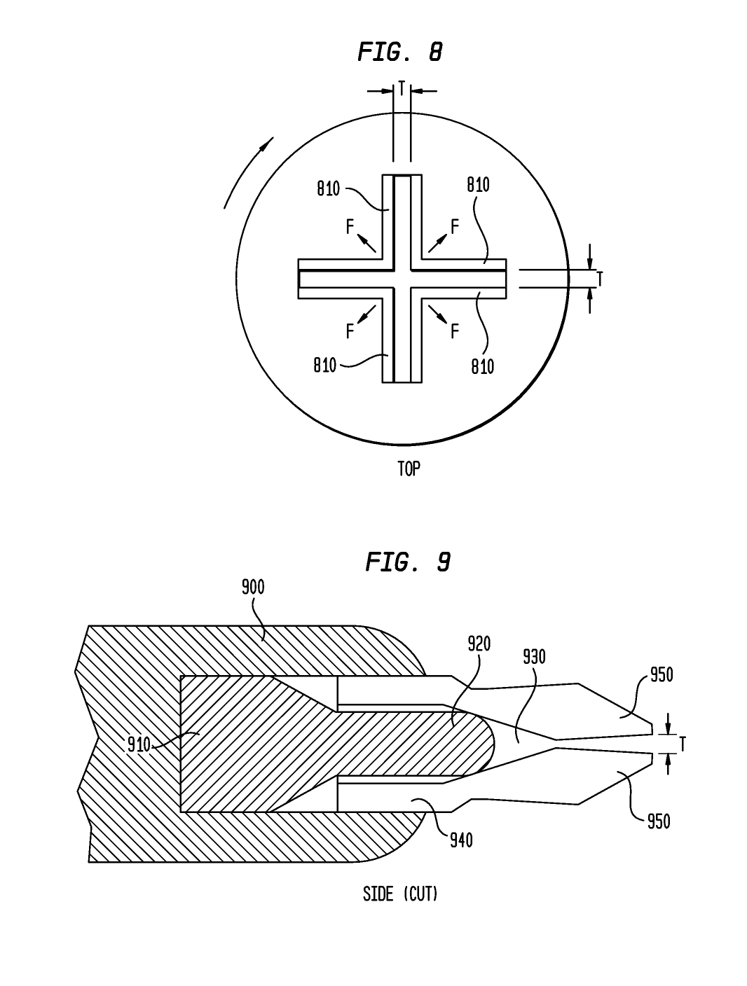

FIG. 8 is a diagram illustrating a top view of prongs 810 of a driving head inserted into a receptacle of a torque-based fastener in an exemplary embodiment. In FIG. 8, the distance between prongs 810 has expanded, enabling prongs 810 to grip the walls of a receptacle of a torque-based fastener. The more torque that is applied to shaft 300, the more force F is applied to hold prongs 810 as they tightly grip the walls of the receptacle. Because prongs 810 have been moved outward, there is a small gap 820 of size T within the receptacle between each of prongs 810.

The above embodiment therefore addresses a number of problems encountered in prior driving systems. For example, because the prongs grip a large fraction of the walls of the receptacle, torque is more evenly distributed when the fastener is driven. Additionally, because driving head 500 is capable of expanding, it can increase in size to fit poorly dimensioned screws without slipping.

FIG. 9 illustrates a further expandable driving bit in an exemplary embodiment. In this further embodiment, prongs 950 of the driving bit are further separated the harder that the driving bit is physically pushed into the head of a screw (or other fastener). In FIG. 9, the driving bit is placed within a screwdriver 900, which includes a hexagonal empty portion for receiving an enhanced driving bit with a hexagonal cross-section. The enhanced driving bit includes a shaft 910 and a separate head 940.

Shaft 910 includes a base with a hexagonal cross-section that has been inserted into the empty part of screwdriver 900. In this embodiment, shaft 910 does not include a threaded portion. Thus, simply by pushing on shaft 910, it is further inserted into head 940.

The portion of head 940 within the empty part of screwdriver 900 also exhibits a hexagonal cross-section. When screwdriver 900 is pressed firmly against a head of a screw, end portion 920 of shaft 910 travels within cavity 930 of head 940 and pushes against the inside portions of prongs 950, forcing them outward to more fully grip the interior of the screw head. At the same time, because the hexagonal empty portion of screwdriver 900 is matched in shape with hexagonal shaft 910 and hexagonal head 940, the rotation of the enhanced driving bit is locked with the rotation of screwdriver 900.

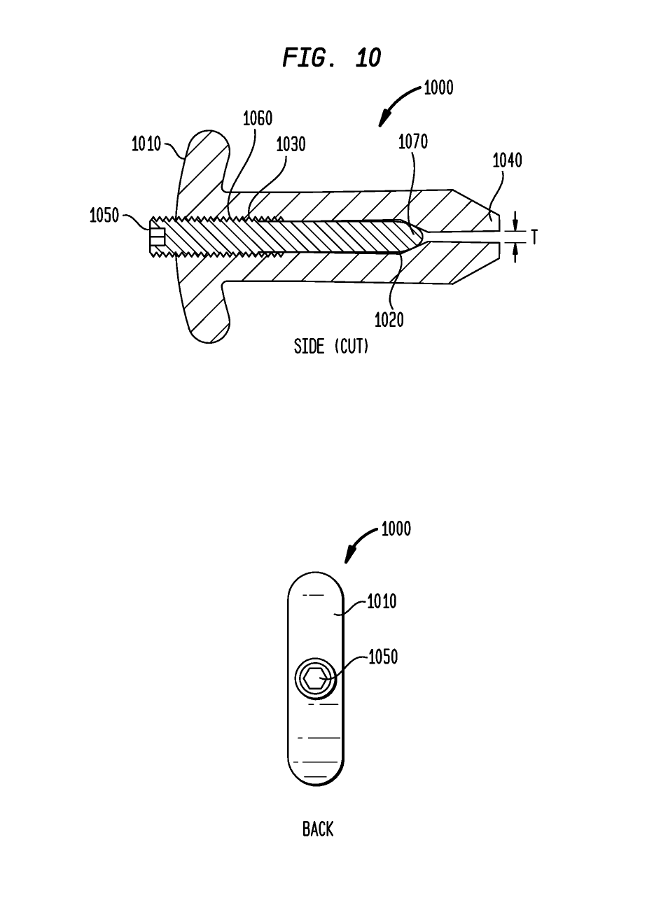

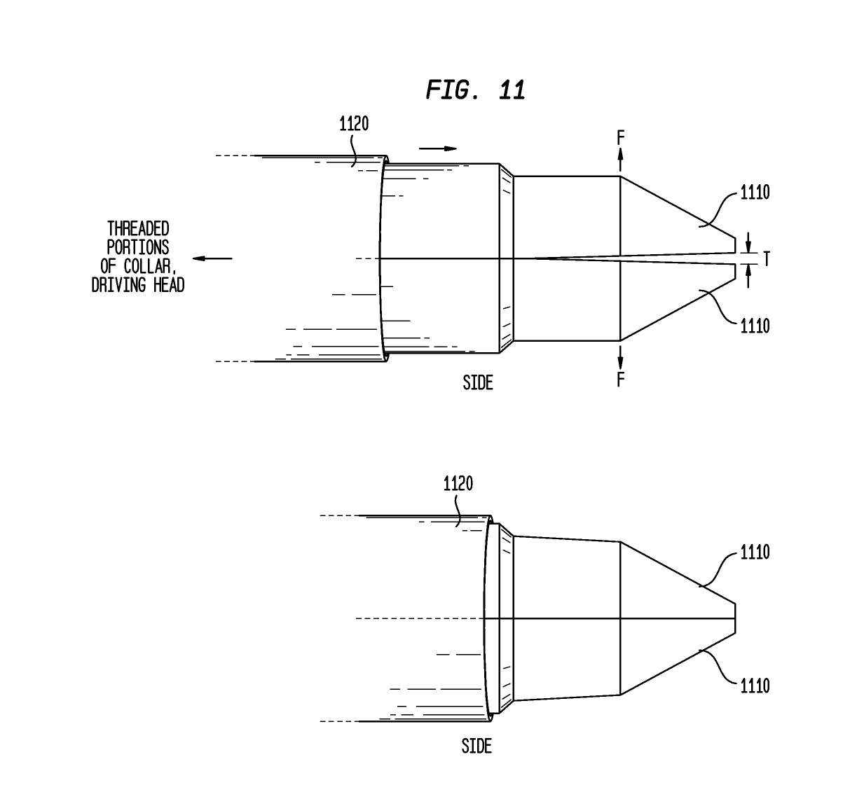

FIG. 10 illustrates a further expandable driving head implemented in a screwdriver 1000 in an exemplary embodiment. Screwdriver 1000 comprises multiple pieces, and shaft 1050 is one of those pieces. Shaft 1050 is used to separate prongs 1040 apart from each other. In this embodiment, a threaded portion 1060 of shaft 1050 is threaded into a threaded void 1030 of interior 1020 of screwdriver 1000. Shaft 1050, when rotated, drives end portion 1070 into prongs 1040, which are integrated into the body of screwdriver 1000. This forces prongs 1040 apart, expanding the size of the driving head of screwdriver 1000. In this embodiment, screwdriver 1000 further includes a handle 1010 to enhance the application of torque to a screw. Screwdriver 1000 may further include mechanical catches or other features to lock the position of shaft 1050 in a specific place when prongs 1040 have been separated by a desired amount. For example, shaft 1050 may be integrated with a ratchet, so that a pawl of the ratchet prevents shaft 1050 from rotating in a given (potentially switchable) direction.

FIG. 11 illustrates a further driving head that utilizes a collar in an exemplary embodiment. According to FIG. 11, prongs 1110 are designed so that in a resting state, they flex outward to exhibit a gap T between their tips. As collar 1120 is moved forward (i.e., as it travels) across prongs 1110, collar 1120 forces the tips of prongs 1110 closer together. Thus, the closer collar 1120 is moved towards the tips of prongs 1110, the closer that the tips of prongs 1110 are driven together, and the smaller that the gap between the prongs becomes. Collar 1120 may be held in place by any appropriate locking mechanism. For example, a threaded portion on the interior of collar 1120 may be dimensioned to match a threaded portion of a rod that prongs 1110 are attached to. In this example, the position of collar 1120 can be adjusted by twisting collar 1120 around the rod that prongs 1110 are attached to. When collar 1120 is threaded onto the rod for prongs 1110, twisting collar 1120 serves to increase or decrease the gap between prongs 1110 as desired. Thus, while in operation, collar 1120 may be drawn towards prongs 1110 to reduce the size of the driving head to easily insert it into a receptacle of a driving head. Then, when the driving head is inside of the receptacle, collar 1120 may be withdrawn, thereby expanding the distance between prongs 1110. This in turn applies force to the edges of the receptacle, more fully gripping those edges.

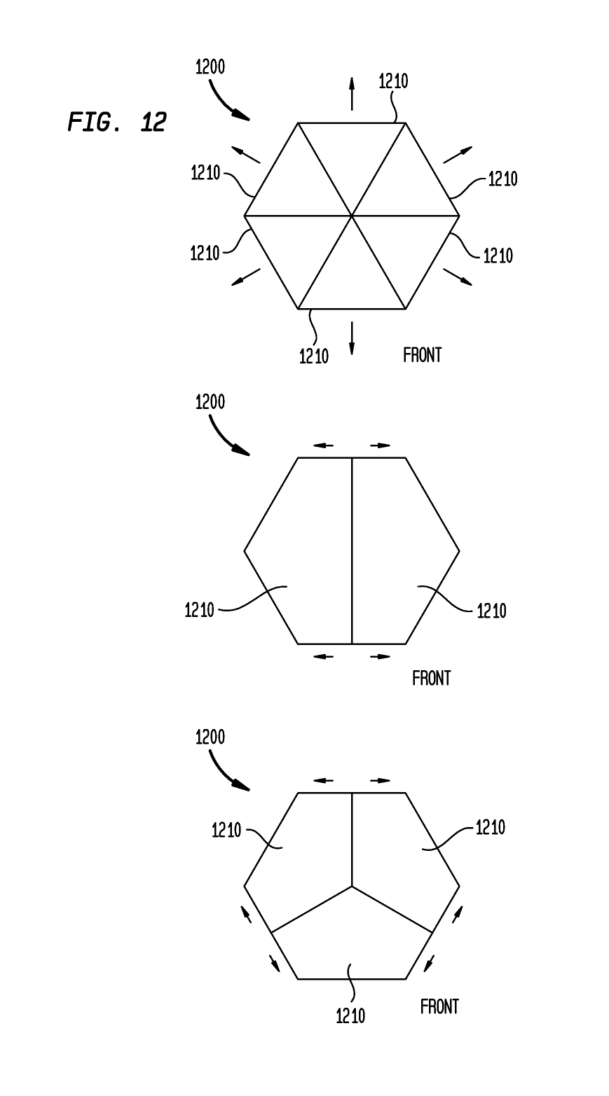

FIG. 12 illustrates examples of front views of hexagonal driving heads 1200 (i.e., “Allen wrench” style driving heads) that include prongs 1210 in an exemplary embodiment. In these examples, hexagonal driving head 1200 is split into two, three, and six prongs 1210, respectively. The arrows in FIG. 12 indicate the direction that the tips of prongs 1210 will move away from each other when the driving head 1200 is fully expanded.

In a further embodiment, each prong of a driving head may comprise a separate mechanical piece. Instead of experiencing mechanical deformation to separate from each other, the prongs may be physically separate elements that are adjustably positioned in relation to each other. For example, the prongs may comprise jaws of a chuck system. In such an embodiment, the tips of the jaws are dimensioned, when they are drawn together, to form a driving head (e.g., a Phillips head driver, a flathead driver, a hexagonal driver, etc.). For example, each prong may comprise a jaw of a keyless chuck system, such as a keyless chuck system described in U.S. Pat. No. 4,252,333 or U.S. Pat. No. 4,260,169, both of which are herein incorporated by reference. In such an embodiment, by expanding the jaws of the chuck, the prongs will separate from each other to more fully engage a loose receptacle of a torque-based fastener. In such embodiments, it may be desirable for the prongs to be replaceable so that they may be replaced after experiencing wear and tear from driving many fasteners.

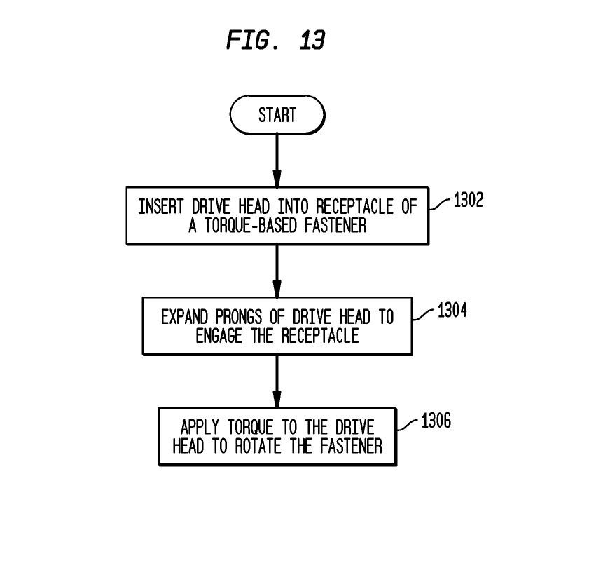

FIG. 13 illustrates an exemplary method for operating an enhanced driving head in accordance with features and aspects hereof. The steps of the flowcharts described herein are not all inclusive and may include other steps not shown. The steps described herein may also be performed in an alternative order.

In step 1302, an enhanced driving head that includes prongs (e.g., driving head 500) is inserted into a receptacle of a torque-based fastener (e.g., a screw). The prongs are adapted, in combination, to engage a receptacle of a torque-based fastener. In step 1304, the distance between the prongs of the driving head are expanded, which causes the prongs to engage the internal walls of the receptacle. This may be performed using any suitable systems and structure described above. In step 1306, torque is applied to the expanded driving head. The driving head transfers the torque to the receptacle of the fastener, which causes the fastener to rotate and drive into or out of a material such as a wall, stud, etc.

In a further embodiment, the prongs of the driving head may be magnetic to facilitate engagement with a torque-based fastener. In an additional further embodiment, a shaft of a driving system (e.g., the driving system described with respect to FIGS. 3-7) may be integrated into a rotatable, geared portion of a ratchet. Thus, the rotation of the shaft of the driving system can be restricted to one direction at a time. For example, a pawl of the ratchet (integrated with the driving head) may contact a gear integrated onto the shaft, and the pawl may prevent rotation of the shaft in a given direction.

The features discussed above may be implemented into any appropriate driving device. For example, the features may be implemented in screwdrivers, bits for screwdrivers, any other driving devices for torque-based fasteners, etc. Furthermore, although specific embodiments were described herein, the scope of the invention is not limited to those specific embodiments. The scope of the invention is defined by the following claims and any equivalents thereof.

I claim:

1. An apparatus comprising:
a driving head comprising multiple prongs, each prong comprising a tip adapted to engage a receptacle of a torque-based fastener, where the tips of the prongs are adapted to elastically deflect apart from each other, thereby expanding a size of the driving head and engaging the receptacle of the torque-based fastener.

2. The apparatus of claim 1, further comprising:
a shaft comprising a threaded portion and an end portion;
where the driving head further comprises:
a shell defining a cavity that includes a threaded void adapted to receive the threaded portion of the shaft,
where the end portion of the shaft is adapted to penetrate the cavity as the threaded portion of the shaft is inserted into the threaded void, and the end portion applies force to elastically deform the prongs to deflect the tips of the prongs away from each other as the end portion penetrates the cavity.

3. The apparatus of claim 2 wherein:
the shell is fixedly attached to a base of each prong, and the shell remains stationary while the tips of the prongs are elastically deflected.

4. The apparatus of claim 2 wherein:
each prong tip comprises a portion of a Philips head screwdriver.

5. The apparatus of claim 2 wherein:
the cavity defined by the shell is further defined by a portion of each prong, and
the end portion of the shaft is further adapted to apply force to each said portion of each prong as it penetrates the cavity.

6. The apparatus of claim 2 wherein:
the threaded portion of the shaft is normally threaded, thereby enabling the end portion to travel further into the cavity as the shaft is driven clockwise.

7. The apparatus of claim 2 wherein:
the threaded portion of the shaft is reverse-threaded, thereby enabling the end portion to travel further into the cavity as the shaft is driven counter-clockwise.

8. The apparatus of claim 2 wherein:
the prongs comprise a shape memory material that returns the prong tips to an unexpanded resting state when the shaft is withdrawn.

9. The apparatus of claim 1 wherein:
the driving head further comprises a chuck, wherein each of the prongs comprises a jaw of the chuck.

10. The apparatus of claim 9 wherein:
the chuck comprises a keyless chuck.

11. The apparatus of claim 1 wherein:
each prong tip comprises a portion of a Philips head screwdriver.

12. The apparatus of claim 1 further comprising:
a collar external to the driving head that is adapted to travel over the prongs, thereby elastically deforming the tips of the prongs closer together.

13. The apparatus of claim 12 wherein:
the driving head comprises a threaded portion along an external surface, and the collar includes a threaded portion adapted to the threaded portion of the driving head, where rotation of the collar along the threading causes the collar to travel over the prongs.

14. The apparatus of claim 12 wherein:
the prongs comprise a shape memory material that returns the tips of the prongs to an expanded resting state when the collar is withdrawn.

15. The apparatus of claim 1, further comprising:
a shaft comprising a base and an end portion;
where the driving head further comprises:
a shell defining a cavity adapted to receive the shaft,
where the end portion of the shaft is adapted to penetrate the cavity as the shaft is inserted into the cavity, and the end portion applies force to deform the prongs and elastically deflects the tips of the prongs away from each other as the end portion penetrates the cavity.

16. A method comprising:
inserting a driving head that includes multiple prongs into a receptacle of a torque-based fastener;
expanding the distance between the tips of the prongs of the driving head, thereby engaging the tips with internal walls of the receptacle; and
applying torque to the expanded driving head.

17. The method of claim 16, wherein
expanding the distance between the prongs of the driving head comprises driving the prongs apart until the prongs apply force to the internal walls of the receptacle.

18. The method of claim 16, wherein
expanding the distance between the prongs of the driving head comprises driving a shaft between the prongs to force the prongs apart.

19. The method of claim 16, wherein
the prongs of the driving head comprise jaws of a keyless chuck, and
expanding the distance between the prongs of the driving head comprises adjusting the keyless chuck.

20. A kit comprising:
a shaft comprising a threaded portion and an end portion; and
a driving head comprising:
a shell defining a cavity that includes a threaded void adapted to receive the threaded portion of the shaft; and
multiple prongs, each prong comprising a tip adapted to engage a receptacle of a torque-based fastener, where the tips of the prongs are adapted to elastically deflect apart from each other, thereby expanding the size of the driving head and engaging the torque-based fastener,
where the end portion of the shaft is adapted to penetrate the cavity as the threaded portion of the shaft is inserted into the threaded void, thereby applying force to elastically deform the prongs, deflecting the tips of the prongs away from each other.
